(19) United States
(12) Patent Application Publication
(10) Pub. No.: US 2024/0394560 A1
(43) Pub. Date: Nov. 28, 2024

(54) INFORMATION PROCESSING APPARATUS, INFORMATION PROCESSING METHOD, AND STORAGE MEDIUM

(71) Applicant: NEC CORPORATION, Minato-ku, Tokyo (JP)

(72) Inventor: Shinji ITO, Tokyo (JP)

(73) Assignee: NEC CORPORATION, Minato-ku, Tokyo (JP)

(21) Appl. No.: 18/695,904

(22) PCT Filed: Oct. 4, 2021
(86) PCT No.: PCT/JP2021/036579

§ 371 Date: Mar. 27, 2024

(51) Int. Cl. G06N 5/01

(52) U.S. Cl. CPC G06N 5/01

(57) ABSTRACT

An information processing apparatus includes: a selection section for selecting a subset Xₜ⊆[n] of a set [n] in a certain round t∈[T] with reference to an observation value of an objective function in a round t−1; and an output section for outputting information indicating the subset Xₜ⊆[n] which has been selected by the selection section, the selection section selecting the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model.

This application is a National Stage Entry of PCT/JP2021/036579 filed on Oct. 4, 2021, the contents of all of which are incorporated herein by reference, in their entirety.

### TECHNICAL FIELD

The present invention relates to an information processing apparatus, an information processing method, and an information processing program for providing a solution to an online optimization problem.

### BACKGROUND ART

An algorithm for carrying out optimization of an indicator under a condition in which a function expressing the indicator to be optimized can sequentially change (such optimization is also called online optimization) is known (e.g., Non-Patent Literature 1).

### CITATION LIST

### Patent Literature

### [Non-Patent Literature 1]

E. Hazan and S. Kale, ‘Online Submodular Minimization’, Journal of Machine Learning Research 13 (2012) 2903-2922

### SUMMARY OF INVENTION

### Technical Problem

In a method disclosed in Non-Patent Literature 1, subsets X₁, X₂, . . . , X_{T} are derived which bound an expected value of a regret Σ_{t∈[T]}fₜ(Xₜ)−min_{X∈S}{Σ_{t∈[T]}fₜ(X)} to be not greater than O(nT^{1/2}).

Meanwhile, online optimization problems are known to be roughly classified into two models below, and a suitable optimization algorithm can vary depending on which one of the models is assumed.
A stochastic model assuming that an objective function follows a stationary probability distribution.
An adversarial model in which an objective function non-stationarily (adversarially) varies.

However, in an online optimization problem, it is generally difficult to acquire a priori information pertaining to which one of a stochastic model and an adversarial model should be assumed. Under the circumstances, a technique has been demanded which makes it possible to suitably provide a solution to an optimization problem with respect to both a stochastic model and an adversarial model without referring to a priori information pertaining to which one of the stochastic model and the adversarial model should be assumed.

An example aspect of the present invention is accomplished in view of the above problem, and an example object thereof is to realize a technique which makes it possible to suitably provide a solution to an optimization problem with respect to both a stochastic model and an adversarial model without referring to a priori information pertaining to which one of the stochastic model and the adversarial model should be assumed.

### Solution to Problem

An information processing apparatus in accordance with an example aspect of the present invention includes at least one processor, the at least one processor carrying out: a selection process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and an output process of outputting information indicating the subset Xₜ⊆[n] which has been selected in the selection process, in the selection process, the at least one processor selecting the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model.

An information processing apparatus in accordance with an example aspect of the present invention includes at least one processor, the at least one processor carrying out: a selection process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and an output process of outputting information indicating the subset Xₜ⊆[n] which has been selected in the selection process, in the selection process, in each round, the at least one processor calculating, for each i∈[n], an n-dimensional vector xₜ∈[0,1]ⁿ by

$${x}_{ti} = \frac{1}{1 + exp ( {G}_{ti} / {λ}_{ti} )}$$

using a learning rate λₜᵢ and a cumulative subgradient Gₜᵢ, the at least one processor calculating, for all i∈[n−1], a permutation σₜ:[n]→[n] where x_{tσ(i)}≤x_{tσ(i+1)}, the at least one processor deciding values of a random variable uₜ which are uniformly distributed on [0,1], the at least one processor deciding a subset Xₜ so that Xₜ={i∈[n]|xₜᵢ≥uₜ} is satisfied, the at least one processor acquiring a value of an objective function fₜ(X), the at least one processor calculating a subgradient gₜ∈R^{d} of an objective function fₜ, and the at least one processor updating a cumulative subgradient Gₜ by Gₜ₊₁=Gₜ+gₜ.

### (Canceled)

An information processing method in accordance with an example aspect of the present invention includes: selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and outputting information indicating the subset Xₜ⊆[n] which has been selected, in the selecting, the subset Xₜ⊆[n] being selected so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and an optimum solution X*, is bounded from above by an upper limit value A(Δ,n,C) which depends at least on a gap indicator Δ in a stochastic model and on a corruption indicator C indicating an adversarial corruption of the stochastic model.

A computer-readable non-transitory storage medium in accordance with an example aspect of the present invention is a computer-readable non-transitory storage medium storing a program for causing a computer to function as the information processing apparatus described above, the program causing the computer to carry out the selection process and the output process.

### Advantageous Effects of Invention

According to an example aspect of the present invention, it is possible to suitably provide a solution to an optimization problem with respect to both a stochastic model and an adversarial model without referring to a priori information pertaining to which one of the stochastic model and the adversarial model should be assumed.

### BRIEF DESCRIPTION OF DRAWINGS

FIG. 1 is a block diagram illustrating a configuration of an information processing apparatus in accordance with a first example embodiment.

FIG. 2 is a flowchart illustrating a flow of an information processing method in accordance with the first example embodiment.

FIG. 3 is a diagram for describing an example advantage by the information processing apparatus in accordance with the first example embodiment.

FIG. 4 is a block diagram illustrating a configuration of an information processing apparatus in accordance with a second example embodiment.

FIG. 5 is a flowchart illustrating a flow of a process in an information processing system in accordance with the second example embodiment.

FIG. 6 is a flowchart illustrating a process example 1 carried out by the information processing apparatus in accordance with the second example embodiment.

FIG. 7 is a flowchart illustrating a process example 2 carried out by the information processing apparatus in accordance with the second example embodiment.

FIG. 8 is a diagram illustrating a display screen example displayed by the information processing apparatus in accordance with the second example embodiment.

FIG. 9 is a block diagram illustrating a configuration of a computer that functions as the information processing apparatuses in accordance with each of the example embodiments.

### EXAMPLE EMBODIMENTS

### First Example Embodiment

The following description will discuss a first example embodiment of the present invention in detail, with reference to the drawings. The present example embodiment is a basic form of example embodiments described later.

### <Overview of Information Processing Apparatus 1>

An information processing apparatus 1 in accordance with the present example embodiment is, schematically speaking, an information processing apparatus that carries out optimization (also called online optimization) of an indicator under a condition in which a function expressing the indicator to be optimized can sequentially change. In other words, the information processing apparatus 1 is an information processing apparatus that provides a solution to an online optimization problem.

For example, the information processing apparatus 1 decides a certain action in a certain round and acquires an observation value related to a result obtained by the certain action. Then, the process of deciding, with reference to the value of the observation value, an action to be carried out in the next round is repeated. Here, it is assumed that a relation between an action and a result is expressed by, for example, an unknown objective function in which the action is an argument and the result is a function value. Therefore, by referring to an action decided in a certain round and a result obtained by the action, the information processing apparatus 1 acquires (local) information pertaining to the objective function.

Examples of the foregoing action include price setting of one or more products. Examples of the foregoing observation value related to the result include an actual amount of sales obtained by the price setting, and an actual amount of loss (calculated by subtracting an actual amount of sales from a target amount of sales) caused by the price setting. Note, however, that the present example embodiment is not limited to these examples. Examples of the foregoing indicator to be optimized include: a regret that is a difference (or an expected value thereof) between a sum total of actual amounts of sales and a sum total of amounts of sales in a case where an ideal (optimum) action has been taken; a regret that is a difference (or an expected value thereof) between a sum total of actual amounts of loss and a sum total of amounts of loss in a case where an ideal (optimum) action has been taken; and the like. Note, however, that the present example embodiment is not limited to these examples.

In the present example embodiment, an online optimization problem to be solved by the information processing apparatus 1 is positioned, for example, as follows.

### (Feasible Area)

An online optimization problem to be solved by the information processing apparatus 1 is, for example, an online optimization problem that is classified into a combination set (family of subsets). Here, in the online optimization problem that is classified into a combination set, a weighted sum or submodularity is assumed as a property of an objective function. In addition, in the online optimization problem that is classified into a combination set, a combination set having a plurality of elements is targeted. Therefore, for example, it is possible to handle a combination of prices of a plurality of products.

### (Amount of Feedback Information)

An online optimization problem to be solved by the information processing apparatus 1 is an online optimization problem based roughly on the following two settings. Here, a full-information setting has a greater amount of feedback information pertaining to an objective function than a bandit-feedback setting.
Full-information setting: After selecting a subset Xₜ (certain action) in a certain round t, it is possible to refer to a value fₜ(X) of an objective function fₜ with respect to an arbitrary subset X (another action).
Bandit-feedback setting: After selecting a subset Xₜ (certain action) in a round t, it is possible to refer to a value fₜ(Xₜ) of an objective function fₜ with respect to the selected subset Xₜ (certain action), and it is impossible to refer to a value fₜ(X) of the objective function fₜ with respect to a subset X (another action) other than the selected subset.

### (Target Model)

Online optimization problems are roughly classified into two models below.
A stochastic model assuming that an objective function follows a stationary probability distribution.
An adversarial model in which an objective function non-stationarily (adversarially) varies.

As described later, the information processing apparatus 1 is configured so that an adversarial corruption with respect to a stochastic model (stochastic model with adversarial corruption) can be quantitatively evaluated using a corruption indicator C. The information processing apparatus 1 carries out an algorithm that is applicable to all of a stochastic model, an adversarial model, and an adversarial corruption with respect to a stochastic model.

Therefore, the information processing apparatus 1 can suitably solve an optimization problem with respect to both a stochastic model and an adversarial model by a hybrid algorithm (best of both worlds algorithm) which is suitably applicable to both the stochastic model and the adversarial model without referring to a priori information pertaining to which one of the stochastic model and the adversarial model should be assumed.

### <Configuration of Information Processing Apparatus 1>

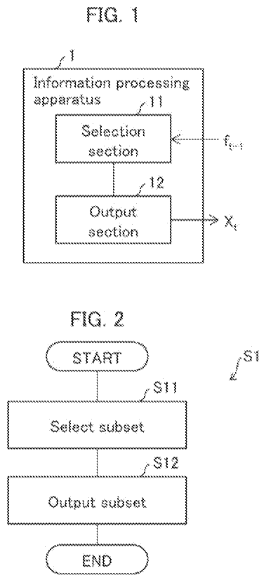

Next, the following description will discuss a configuration of the information processing apparatus 1 in accordance with the present example embodiment. FIG. 1 is a block diagram illustrating the configuration of the information processing apparatus 1 in accordance with the present example embodiment. As illustrated in FIG. 1, the information processing apparatus 1 includes a selection section 11 and an output section 12.

The selection section 11 selects a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1.

The output section 12 outputs information indicating the subset Xₜ⊆[n] which has been selected by the selection section 11.

Here, the subset Xₜ is a subset that defines an action in the round t. For example, the subset Xₜ has a meaning as a subset including identification information of a product as an element. Note, however, that the present example embodiment is not limited to this. Examples of the foregoing objective function include an objective function that defines a relation between an action and an amount of sales, and an objective function that defines a relation between an action and an amount of loss. Note, however, that the present example embodiment is not limited to these examples.

Each of elements of a set [n]={1, 2, . . . , n} (where n is an arbitrary natural number) in accordance with the present example embodiment corresponds, in a one-to-one manner, to each of n elements constituting an arbitrary set S. Therefore, a process described in the present example embodiment can be applied to an arbitrary set S consisting of n elements.

The selection section 11 in accordance with the present example embodiment selects the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model. Note that the comparative solution is, for example, an optimum solution that minimizes an objective function expressing a loss.

In a case where an objective function expressing an amount of sales is used, a function in which the sign of the above described regret is reversed may be used. In other words, it is possible to express that the subset Xₜ⊆[n] is selected so that an asymptotic behavior of an absolute value of an expected value of the regret Σ_{t∈[T]}fₜ(Xₜ)−Σ_{t∈[T]}fₜ(X*) is bounded from above by an upper limit value A(Δ,n,C) which depends at least on a gap indicator Δ in a stochastic model and on a corruption indicator C indicating an adversarial corruption of the stochastic model.

In the present example embodiment, the objective function fₜ is, for example, a function (submodular function) satisfying submodularity. That is, the objective function fₜ satisfies, for an arbitrary subset X,Y satisfying X,Y⊆[n], the following inequality: fₜ(X∩Y)+fₜ(X∪Y)≤fₜ(X)+fₜ(Y). Note, however, that the present example embodiment is not limited to this.

A destination to which the output section 12 outputs information indicating the subset Xₜ⊆[n] does not limit the present example embodiment and, for example, a configuration may be employed in which the output section 12 includes a display panel and information indicating the subset Xₜ is displayed on the display panel. Alternatively, a configuration may be employed in which the output section 12 provides another apparatus with information indicating the subset Xₜ, and the another apparatus displays the information or refers to the information to automatically update a price of a product or the like.

The gap indicator is expressed as

$$Δ = {min}_{{2}^{[ n ]} \backslash \{ {X}^{*} \}} ( \overline{f} ( X ) - \overline{f} ( {X}^{*} ) )$$

using an expected value

$$\overline{f} ( X ) = {E}_{f ∼ 𝒟} [ f ( X ) ]$$

of the objective function fₜ in a case where the objective function fₜ follows a probability distribution D.

The corruption indicator C is expressed as

$$C = {\sum }_{t = 1}^{T} {max}_{X ⊆ [ n ]} \vert {f}_{t} ( X ) - {f}_{t}^{′} ( X ) \vert$$

using the objective function fₜ and a time-dependent objective function fₜ′.

In the information processing apparatus 1 configured as described above, an expected value of a regret is bounded from above by an upper limit value A(Δ,n,C). Here, the upper limit value is defined so as to encompass both a stochastic model and an adversarial model, and is expressed using a corruption indicator C indicating an adversarial corruption of the stochastic model, as described above. Therefore, according to the information processing apparatus 1 configured as described above, it is possible to suitably solve an optimization problem with respect to both a stochastic model and an adversarial model.

### <Information Processing Method>

The following description will discuss a flow of an information processing method S1 which is carried out by the information processing apparatus 1, with reference to FIG. 2. FIG. 2 is a flowchart illustrating the flow of the information processing method S1 which is carried out by the information processing apparatus 1.

### (Step S11)

In step S11, the selection section 11 selects a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1.

### (Step S12)

In step S12, the output section 12 outputs information indicating the subset Xₜ⊆[n] which has been selected by the selection section 11.

Here, in step S11, the selection section 11 selects the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model. Note that the comparative solution is, for example, an optimum solution that minimizes an objective function expressing a loss, as described above.

In the information processing method S1 configured as described above, an expected value of a regret is bounded from above by an upper limit value A(Δ,n,C). Here, the upper limit value is defined so as to encompass both a stochastic model and an adversarial model, and is expressed using a corruption indicator C indicating an adversarial corruption of the stochastic model, as described above. Therefore, according to the information processing method S1 as described above, it is possible to suitably solve an optimization problem with respect to both a stochastic model and an adversarial model.

(Comparison of an Algorithm by Information Processing Method S1 with Other Algorithms)

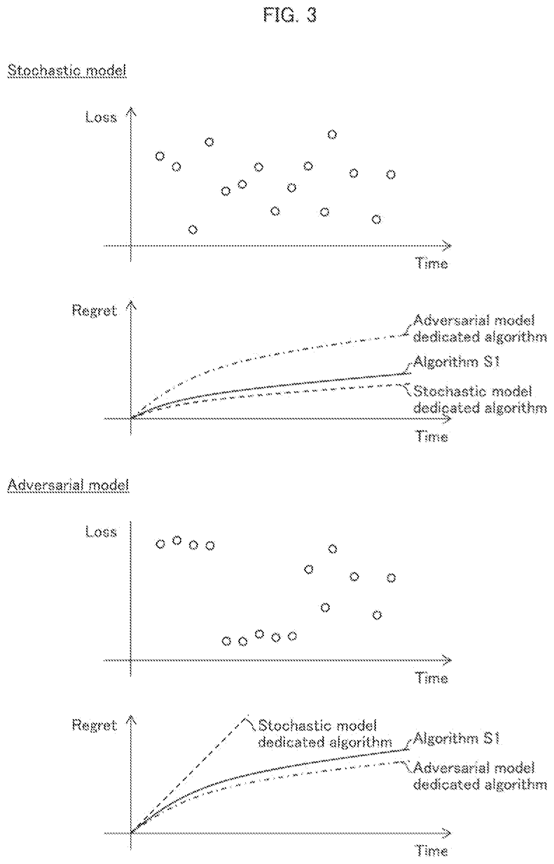

FIG. 3 is a diagram schematically illustrating an example advantage of an algorithm by the information processing method S1 in accordance with the present example embodiment. The first graph from the top in FIG. 3 is a diagram schematically illustrating a relation between a loss (objective function) and a time (round) in a stochastic model (more specifically, a status in which the stochastic model is suitably applied; the same applies hereinafter). The second graph from the top in FIG. 3 is a diagram schematically illustrating a relation between a time and a regret by each of algorithms (an adversarial model dedicated algorithm, a stochastic model dedicated algorithm, and an algorithm S1 (i.e., an algorithm by the information processing method S1)) which have been applied to the stochastic model.

As indicated in the first graph from the top in FIG. 3, in the stochastic model, it is assumed that an objective function follows an unknown distribution. Here, the unknown distribution is, for example, a (stationary) uniform probability distribution which is independent of time. In such a condition, a regret by the adversarial model dedicated algorithm is greater than a regret by the stochastic model dedicated algorithm, as indicated in the first graph from the top in FIG. 3. Meanwhile, with the algorithm S1, a regret is bounded from above by the upper limit value A(Δ,n,C). Therefore, a regret by the algorithm S1 is smaller than the regret by the adversarial model dedicated algorithm.

The third graph from the top in FIG. 3 is a diagram schematically illustrating a relation between a loss (objective function) and a time (round) in an adversarial model (more specifically, a status in which the adversarial model is suitably applied; the same applies hereinafter). The fourth graph from the top in FIG. 3 is a diagram schematically illustrating a relation between a time and a regret by each of algorithms (an adversarial model dedicated algorithm, a stochastic model dedicated algorithm, and an algorithm S1 (i.e., an algorithm by the information processing method S1)) which have been applied to the adversarial model.

As indicated in the third graph from the top in FIG. 3, an objective function is assumed to non-stationarily behave in the adversarial model. More specifically, an objective function fₜ in a round t depends on a sequence (X₁, X₂, . . . , Xₜ₋₁) of subsets which have been selected before and at a round t−1. In such a condition, a regret by the stochastic model dedicated algorithm is greater than a regret by the adversarial model dedicated algorithm, as indicated in the fourth graph from the top in FIG. 3. Meanwhile, with the algorithm S1, a regret is bounded from above by the upper limit value A(Δ,n,C). Therefore, a regret by the algorithm S1 is smaller than the regret by the stochastic model dedicated algorithm.

As such, according to the information processing apparatus 1 and the information processing method S1 described above, it is possible to suitably solve an optimization problem with respect to both a stochastic model and an adversarial model.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### <Overview of Information Processing System 100A>

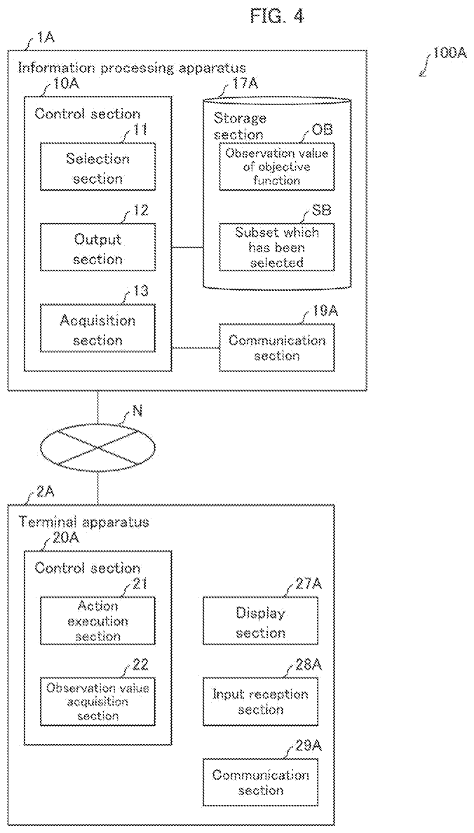

The following description will discuss a configuration of an information processing system 100A in accordance with the present example embodiment, with reference to FIG. 4. FIG. 4 is a block diagram illustrating a configuration of the information processing system 100A. As illustrated in FIG. 4, the information processing system 100A includes an information processing apparatus 1A and a terminal apparatus 2A. Moreover, as illustrated in FIG. 4, the information processing apparatus 1A and the terminal apparatus 2A are configured to communicate with each other via a network N. A specific configuration of the network N does not limit the present example embodiment, and the network N is, for example, a wireless local area network (LAN), a wired LAN, a wide area network (WAN), a public network, a mobile data communication network, or a combination of these networks.

### <Configuration of Information Processing Apparatus 1A>

As illustrated in FIG. 4, the information processing apparatus 1A includes a control section 10A, a storage section 17A, and a communication section 19A.

The storage section 17A stores an observation value OB of an objective function which has been received from the terminal apparatus 2A (described later). In addition, the storage section 17A stores a subset SB which has been selected by the selection section 11.

The communication section 19A communicates with an apparatus external to the information processing apparatus 1A. For example, the communication section 19A communicates with the terminal apparatus 2A. The communication section 19A transmits data supplied from the control section 10A to the terminal apparatus 2A and supplies data received from the terminal apparatus 2A to the control section 10A.

### (Control Section 10A)

As illustrated in FIG. 4, the control section 10A includes a selection section 11, an output section 12, and an acquisition section 13.

The acquisition section 13 acquires an observation value OB of an objective function fₜ in each round t∈[T] (where T is an arbitrary natural number) from the terminal apparatus 2A via the communication section 19A. The acquisition section 13 causes the storage section 17A to store the acquired observation value OB of the objective function. Here, information that the acquisition section 13 can acquire may vary in accordance with whether the setting is a full-information setting or a bandit-feedback setting.

In the full-information setting, the acquisition section 13 can acquire an observation value fₜ(X) of an objective function with respect to an arbitrary subset X⊆[n], the observation value fₜ(X) being obtained after the output section 12 has output a subset Xₜ in a round t.

Meanwhile, in the bandit-feedback setting, the acquisition section 13 can acquire an observation value fₜ(Xₜ) of an objective function with respect to the selected subset Xₜ, the observation value fₜ(Xₜ) being obtained after the output section 12 has output a subset Xₜ in a round t. However, in the bandit-feedback setting, the acquisition section 13 cannot acquire an observation value fₜ(X) of an objective function with respect to a subset X⊆[n] other than the selected subset.

Here, as with the first example embodiment, the subset Xₜ is a subset that defines an action in the round t. For example, the subset Xₜ has a meaning as a subset including identification information of a product as an element. Note, however, that the present example embodiment is not limited to this. Examples of the foregoing objective function include an objective function that defines a relation between an action and an amount of sales, and an objective function that defines a relation between an action and an amount of loss. Note, however, that the present example embodiment is not limited to these examples.

The selection section 11 selects a subset Xₜ⊆[n] of a set [n]={1, 2, . . . , n} (where n is an arbitrary natural number) in a certain round with reference to an observation value of an objective function in a round t−1.

Here, the selection section 11 in accordance with the present example embodiment selects the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model. Note that a comparative solution is, for example, an optimum solution that minimizes an objective function expressing a loss, as with the first example embodiment. A specific process carried out by the selection section 11 will be described later.

The output section 12 outputs information indicating the subset Xₜ⊆[n] which has been selected by the selection section 11. A destination to which the output section 12 outputs information indicating the subset Xₜ⊆[n] does not limit the present example embodiment and, for example, a configuration may be employed in which the output section 12 transmits the information to the terminal apparatus 2A via the communication section 19A. Alternatively, a configuration may be employed in which the output section 12 includes a display panel and information indicating the subset Xₜ is displayed on the display panel.

### <Configuration of Terminal Apparatus 2A>

As illustrated in FIG. 4, the terminal apparatus 2A includes a control section 20A, a display section 27A, an input reception section 28A, and a communication section 29A. The terminal apparatus can be specifically implemented as, for example, an information processing terminal or the like that is disposed in a store. Note, however, that the present example embodiment is not limited to this.

The communication section 29A communicates with an apparatus external to the terminal apparatus 2A. For example, the communication section 29A communicates with the information processing apparatus 1A. The communication section 29A transmits data supplied from the control section 20A to the information processing apparatus 1A and supplies data received from the information processing apparatus 1A to the control section 20A.

The display section 27A displays data for display supplied from the control section 20A. For example, the display section 27A displays information indicating the subset Xₜ which has been selected by the selection section 11 of the information processing apparatus 1A and supplied to the terminal apparatus 2A.

The input reception section 28A receives various kinds of input to the terminal apparatus 2A. For example, the input reception section 28A receives an observation value of an objective function in each round t. Then, the input reception section 28A supplies the received observation value to the control section 20A. The supplied observation value is transmitted to the information processing apparatus 1A via the communication section 29A and is acquired by the acquisition section 13 described above. The input reception section 28A may be configured to receive the observation value via an operation by a user, or may be configured to automatically acquire the observation value.

A specific configuration of the input reception section 28A does not limit the present example embodiment and, for example, the input reception section 28A may be configured to include an input device such as a keyboard, a touch pad, and the like. Alternatively, a configuration may be employed in which the input reception section 28A includes a data scanner or the like that reads data via electromagnetic waves such as infrared rays or radio waves.

### (Control Section 20A)

As illustrated in FIG. 4, the control section 20A includes an action execution section 21 and an observation value acquisition section 22.

The action execution section 21, in each round t, acquires information indicating the subset Xₜ which has been selected by the selection section 11 of the information processing apparatus 1A, and carries out an action corresponding to the acquired subset Xₜ. For example, the action execution section 21 updates prices of one or more products indicated by the subset Xₜ with reference to information indicating the subset Xₜ. Alternatively, it is possible to employ a configuration in which the action execution section 21 generates display data indicating the subset Xₜ and supplies the generated display data to the display section 27A, and the display section 27A displays the display data. In this configuration, a user updates prices of one or more products with reference to the display data displayed by the display section 27A.

The observation value acquisition section 22 acquires, via the input reception section 28, an observation value of an objective function after the action execution section 21 has carried out an action. The observation value of the objective function acquired by the observation value acquisition section 22 is supplied to the information processing apparatus 1A via the communication section 29A and is acquired by the acquisition section 13 of the information processing apparatus 1A.

### <Flow of Process by Information Processing System 100A>

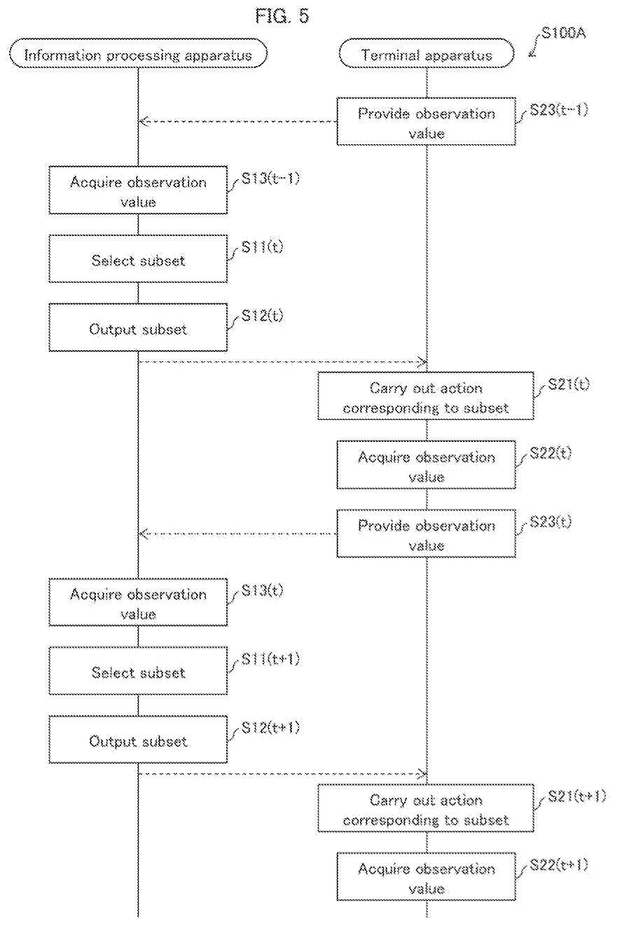

Next, the following description will discuss, with reference to FIG. 5, a flow of an information processing method S100A (also referred to as an algorithm 1) by the information processing system 100A in accordance with the present example embodiment. In the descriptions below, rounds are distinguished from each other in a manner in which “(t−1)” is given to each step in a round t−1, “(t)” is given to each step in a round t, and so forth.

### (Step S23(t−1))

As illustrated in FIG. 5, the terminal apparatus 2A provides, in step S23(t−1), an observation value fₜ of an objective function to the information processing apparatus 1A. Here, an observation value which can be provided by the terminal apparatus 2A can vary in accordance with whether the setting is the full-information setting or the bandit-feedback setting described above.

In the full-information setting, in step S23(t−1), the terminal apparatus 2A can provide an observation value fₜ₋₁(X) of an objective function with respect to an arbitrary subset X⊆[n], the observation value fₜ₋₁(X) being obtained after the output section 12 has output a subset Xₜ₋₁ in a round t−1.

Meanwhile, in the bandit-feedback setting, the terminal apparatus 2A can acquire, in step S23(t−1), an observation value fₜ₋₁(Xₜ₋₁) of an objective function with respect to the selected subset Xₜ₋₁, the observation value fₜ₋₁(Xₜ₋₁) being obtained after the output section 12 has output the subset Xₜ₋₁ in the round t−1. However, in the bandit-feedback setting, the terminal apparatus 2A cannot acquire, in step S23(t−1), an observation value fₜ₋₁(X) of an objective function with respect to a subset X⊆[n] other than the selected subset.

### (Step S13(t−1))

Next, in step S13(t−1), the acquisition section 13 of the information processing apparatus 1A acquires the observation value fₜ₋₁ of the objective function which has been provided by the terminal apparatus 2A in step S23(t−1).

### (Step S11(t))

Next, in step S11(t), the selection section 11 of the information processing apparatus 1A selects a subset Xₜ⊆[n] with reference to the observation value fₜ₋₁ of the objective function which has been acquired by the acquisition section in step S13(t−1). A specific process carried out by the selection section 11 will be described later.

### (Step S12(t))

Next, in step S12(t), the output section 12 outputs information indicating the subset Xₜ⊆[n] which has been selected by the selection section 11 in step S11(t). The information indicating the outputted subset Xₜ⊆[n] is transmitted to the terminal apparatus 2A via the communication section 19A.

### (Step S21(t))

Next, in step S21(t), the action execution section 21 of the terminal apparatus 2A carries out an action corresponding to the information indicating the subset Xₜ⊆[n] which has been output by the output section 12 in step S12(t). A specific process carried out by the action execution section 21 has been described above, and thus a description thereof is omitted here.

### (Step S22(t))

Next, in step S22(t), the observation value acquisition section 22 of the terminal apparatus 2A acquires an observation value of an objective function which is obtained after the action carried out by the action execution section 21 in step S21(t).

### (Step S23(t))

Next, in step S23(t), the terminal apparatus 2A provides the information processing apparatus 1A with the observation value of the objective function which has been acquired in step S22(t).

Subsequently, as illustrated in FIG. 5, a round in which the foregoing steps are carried out is repeated.

### Process Example 1 by Information Processing Apparatus 1A: Full-Information Setting

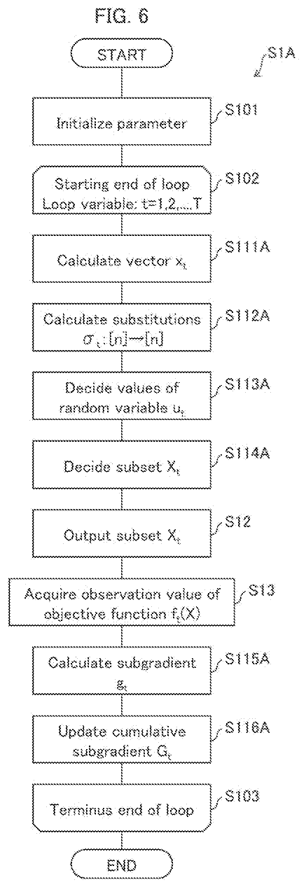

Next, the following description will discuss, with reference to FIG. 6, a flow of a process example 1 (algorithm 1) by the information processing apparatus 1A. The process example 1 indicates a process carried out by the information processing apparatus 1A in the full-information setting.

### (Step S101)

First, in step S101, the selection section 11 initializes various parameters to be used in processing. For example, the selection section 11 initializes a cumulative subgradient G₁ in a first round by G₁ᵢ=0∈Rⁿ. Here, i is an index satisfying i∈[n], and [n] is a set of natural numbers [n]={1, 2, . . . , n} (where n is an arbitrary natural number).

### (Step S102)

Step S102 is a starting end of a loop process that is expressed by a loop variable t (t=1, 2, . . . , T) (where T is an arbitrary natural number). Here, the loop variable t is an index indicating a round number.

### (Step S111A)

In step S111A, the selection section 11 calculates a vector xₜ∈[0,1]ⁿ by the following formula.

$${x}_{ti} = \frac{1}{1 + exp ( {G}_{ti} / {λ}_{ti} )}$$

Here, λₜᵢ is a parameter indicating a learning rate, and is defined by the following formula.

$${λ}_{ti} = 2 + \frac{1}{log 2} {\sum }_{s = 1}^{t - 1} {λ}_{ti} h ( \frac{{g}_{ti}}{{λ}_{ti}} , {x}_{ti} )$$

Here, h is defined, for all z∈[0,1] and g∈R, by the following formula.

$$h ( g , z ) = λ \cdot log ( 1 - z + z exp ( g ) ) - zg$$

### (Step S112A)

Next, in step S112A, the selection section 11 calculates, for all i∈[n−1], a permutation σₜ:[n]→[n] where x_{tσ}(i)≤x_{tσ(i+1)}.

### (Step S113A)

Next, in step S113A, the selection section 11 decides values of a random variable uₜ which are uniformly distributed on [0,1]. In other words, the selection section 11 decides values of the variable uₜ in accordance with a uniform probability distribution on [0,1].

### (Step S114A)

Next, in step S114A, the selection section 11 decides a subset Xₜ so that Xₜ={i∈[n]|xₜᵢ≥uₜ} is satisfied.

### (Step S12)

Next, in step S12, the output section 12 outputs the subset Xₜ which has been selected by the selection section 11 in step S114A. The output subset Xₜ is, for example, supplied to the terminal apparatus 2A, and an action corresponding to the subset Xₜ is carried out in an environment on the terminal apparatus 2A side.

### (Step S13)

Next, in step S13, the acquisition section 13 acquires an observation value fₜ(X) of an objective function fₜ. In this step, the acquisition section 13 can acquire an observation value fₜ(X) of an objective function with respect to an arbitrary subset X⊆[n], the observation value fₜ(X) being obtained after the output section 12 has output a subset Xₜ in step S12.

### (Step S115A)

Next, in step S115A, the selection section 11 calculates a subgradient gₜ∈R^{d} by the following formula.

$${g}_{t} {\sum }_{i = 0}^{n} {f}_{t} ( {σ}_{t} ( [ i ] ) {ρ}_{i} ( {σ}_{t} )$$

Here, ρᵢ(σₜ) is defined by the following formula.

$${ρ}_{i} ( σ ) = \{ \begin{matrix}\begin{matrix}{χ}_{σ ( 1 )} \\ {χ}_{σ ( i + 1 )} - {χ}_{σ ( i )} \\ - {χ}_{σ ( n )}\end{matrix} & \begin{matrix}i = 0 \\ i ∈ [ n - 1 ] \\ i = n\end{matrix}\end{matrix}$$

xᵢ∈{0,1}ⁿ represents an indicator vector of i. Only when i=j, xᵢⱼ=1.

### (Step S116A)

Next, in step S116A, the selection section 11 updates the cumulative subgradient Gₜ by Gₜ₊₁=Gₜ+gₜ.

### (Step S103)

Step S103 is a terminus end of the loop process expressed by the loop variable t.

### (Theorem 1)

The inventors of the present application have succeeded in proving that a regret

$${R}_{T} = {max}_{{X}^{*} ⊆ [ n ]} E [ {\sum }_{t = 1}^{T} {f}_{t} ( {X}_{i} ) - {\sum }_{t = 1}^{T} {f}_{t} ( {X}^{*} ) ] .$$

obtained by the above-described processing example 1 (algorithm 1) is bound from above by

$${R}_{T} = O ( E [ \sqrt{n {\sum }_{t = 1}^{T} {max}_{i ∈ [ n ]} \{ min \{ {x}_{ti} , 1 - {x}_{ti} \} \}} ] )$$

(theorem 1). The inventors of the present application have also indicated that, as a system of theorem 1, the regret R_{T} is bound from above as below.

$${R}_{T} = \{ \begin{matrix}O ( \sqrt{nT} ) & ( adversarial model ) \\ O ( \frac{n}{Δ} ) & ( stochastic model ) \\ O ( \frac{n}{Δ} + \sqrt{\frac{Cn}{Δ}} ) & ( \begin{matrix}stochastic model \\ with adversarial corruption\end{matrix} )\end{matrix}$$

In other words, it has been indicated that the regret R_{T} is bounded from above by an upper limit value A(Δ,n,C) which depends on Δ, n, and C.

Here, the parameter Δ≥0 represents a suboptimality gap in a stochastic model. More specifically, the parameter Δ is expressed as

$$Δ = {min}_{{2}^{[ n ]} \backslash \{ {X}^{*} \}} ( \overline{f} ( X ) - \overline{f} ( {X}^{*} ) ) , \\ where \\ {X}^{*} ∈ {arg min}_{X ⊆ [ n ]} \overline{f} ( X )$$

using an expected value

$$\overline{f} ( X ) = {E}_{f ∼ 𝒟} [ f ( X ) ]$$

of an objective function fₜ in a case where the objective function fₜ follows an unknown distribution D.

The parameter C represents a corruption indicator, and the corruption indicator C is expressed as

$$C = {\sum }_{t = 1}^{T} {max}_{X ⊆ [ n ]} \vert {f}_{t} ( X ) - {{f}_{t}}^{′} ( X ) \vert$$

using the objective function fₜ and a time-dependent objective function fₜ′. Here, the time-dependent objective function fₜ′ is selected from the unknown distribution D which is independent of a round.

In the information processing apparatus 1A configured as described above, in the full-information setting, an expected value of a regret is bounded from above by an upper limit value A(Δ,n,C) which depends on Δ, n, and C, by carrying out the algorithm 1. Therefore, according to the information processing apparatus 1 configured as described above, in the full-information setting, it is possible to suitably solve an optimization problem with respect to both a stochastic model and an adversarial model.

### Process Example 2 by Information Processing Apparatus 1A: Bandit-Feedback Setting

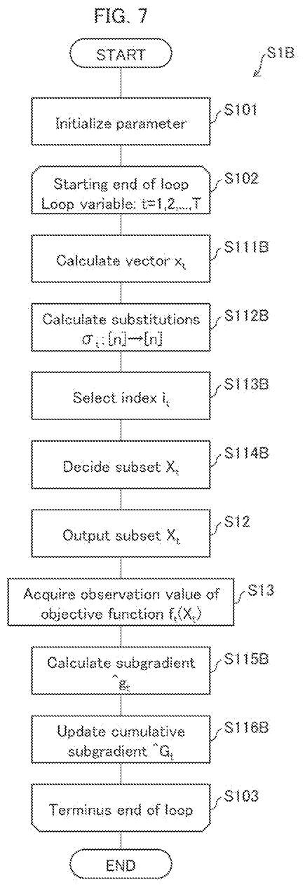

Next, the following description will discuss, with reference to FIG. 7, a flow of a process example 2 (algorithm 2) by the information processing apparatus 1A. The process example 2 indicates a process carried out by the information processing apparatus 1A in the bandit-feedback setting.

### (Step S101)

First, in step S101, the selection section 11 initializes various parameters to be used in processing. For example, the selection section 11 initializes a cumulative subgradient \hat{ }G₁ in a first round by \hat{ }G₁ᵢ=0∈Rⁿ. Here, i is an index satisfying i∈[n], and [n] is a set of natural numbers [n]={1, 2, . . . , n} (where n is an arbitrary natural number). Moreover, \hat{ }Gₜᵢ represents “Gₜᵢ” with a hat “\hat{ }”.

### (Step S102)

Step S102 is a starting end of a loop process that is expressed by a loop variable t (t=1, 2, . . . , T) (where T is an arbitrary natural number). Here, the loop variable t is an index indicating a round number.

### (Step S111B)

In step S111B, the selection section 11 calculates, for each i∈[n], an n-dimensional vector xₜ∈[0,1]ⁿ by xₜᵢ=ζ(\hat{ }Gₜᵢ/λₜ) using a learning rate λₜ, a cumulative subgradient \hat{ }Gₜᵢ, and a function ζ below.

$$ζ ( z ) = \{ \begin{matrix}\frac{1}{2} ( 1 + \frac{2}{g} - \sqrt{1 + \frac{4}{{g}^{2}}} ) & ( g > 0 ) \\ \frac{1}{2} ( 1 + \frac{2}{g} + \sqrt{1 + \frac{4}{{g}^{2}}} ) & ( g < 0 ) \\ 1 / 2 & ( g = 0 )\end{matrix}$$

Here, the learning rate λt is defined by the following formula.

$${λ}_{t} = 2 + {( \frac{1}{\sqrt{n} log T} {\sum }_{s = 1}^{t - 1} \sqrt{{\sum }_{i = 1}^{n} min {\{ {x}_{si} , 1 - {x}_{si} \}}^{2}} )}^{2 / 3}$$

### (Step S112B)

Next, in step S112B, the selection section 11 calculates, for all i∈[n−1], a permutation σₜ:[n]→[n] where x_{tσ(i)}≤x_{tσ(i+1)}.

### (Step S113B)

In step S113B, the selection section 11 selects an index iₜ∈{0, 1, . . . , n} in accordance with a probability below.

$$P r o b [ {i}_{t} = i ] = {p}_{t} ( i ) = ( 1 - {γ}_{t} ) ( {x}_{t {σ}_{i} ( i + 1 )} - {x}_{i {σ}_{i} ( i )} ) + \frac{{γ}_{t}}{n + 1} , \\ where \\ {γ}_{t} \sqrt{\frac{n}{{λ}_{t}} {\sum }_{i = 1}^{n} min {\{ {x}_{ti} , 1 - {x}_{ti} \}}^{2}} .$$

### (Step S114B)

In step S114B, the selection section 11 decides a subset Xₜ so that Xₜ=σₜ([iₜ])={σₜ(j)|j∈[iₜ]} is satisfied.

### (Step S12)

Next, in step S12, the output section 12 outputs the subset Xₜ which has been selected by the selection section 11 in step S114B. The output subset Xₜ is, for example, supplied to the terminal apparatus 2A, and an action corresponding to the subset Xₜ is carried out in an environment on the terminal apparatus 2A side.

### (Step S13)

Next, in step S13, the acquisition section 13 acquires an observation value fₜ(X) of an objective function fₜ. In this step, the acquisition section 13 can acquire an observation value fₜ(Xₜ) of an objective function with respect to the selected subset Xₜ, the observation value fₜ(Xₜ) being obtained after the output section 12 has output a subset Xₜ in step S12. However, in this step, the acquisition section 13 cannot acquire an observation value fₜ(X) of an objective function with respect to a subset X⊆[n] other than the selected subset.

### (Step S115B)

Next, in step S115B, the selection section 11 calculates a subgradient \hat{ }gₜ∈R^{d} by the following formula.

$${\hat{g}}_{t} = \frac{1}{{p}_{i} ( {i}_{t} )} {f}_{t} ( {X}_{t} ) {ρ}_{{i}_{t}} ( {σ}_{t} )$$

Here, \hat{ }gₜ represents “gₜ” with a hat “\hat{ }”. Moreover, ρᵢ(σₜ) is defined by

$${ρ}_{i} ( σ ) = \{ \begin{matrix}\begin{matrix}{χ}_{σ ( 1 )} \\ {χ}_{σ ( i + 1 )} - {χ}_{σ ( i )} \\ - {χ}_{σ ( n )}\end{matrix} & \begin{matrix}i = 0 \\ i ∈ [ n - 1 ] \\ i = n\end{matrix}\end{matrix} ,$$

as described above.

### (Step S116B)

Next, in step S116B, the selection section 11 updates the cumulative subgradient \hat{ }Gₜ by \hat{ }Gₜ₊₁=\hat{ }Gₜ+\hat{ }gₜ.

### (Step S103)

Step S103 is a terminus end of the loop process expressed by the loop variable t.

### (Theorem 2)

The inventors of the present application have succeeded in proving that a regret

$${R}_{T} = {max}_{{X}^{*} ⊆ [ n ]} E [ {\sum }_{t = 1}^{T} {f}_{t} ( {X}_{i} ) - {\sum }_{t = 1}^{T} {f}_{t} ( {X}^{*} ) ]$$

obtained by the above-described processing example 2 (algorithm 2) is bound from above by

$${R}_{T} = O ( E [ {( {n}^{2} log T )}^{1 / 3} {( {\sum }_{t = 1}^{T} \sqrt{{{\sum }_{t = 1}}^{n} \{ min {\{ {x}_{ti} , 1 - {x}_{ti} \}}^{2}} )}^{2 / 3} ] )$$

(theorem 2). The inventors of the present application have also indicated that, as a system of theorem 2, the regret R_{T} is bound from above as below.

$${R}_{T} = \{ \begin{matrix}O ( {{nT}^{2 / 3} ( log T )}^{1 / 3} ) & ( adversarial model ) \\ O ( \frac{{n}^{3} log T}{{Δ}^{2}} ) & ( stochastic model ) \\ O ( \frac{{n}^{3} log T}{{Δ}^{2}} + {( \frac{{C}^{2} {n}^{3} log T}{{Δ}^{2}} )}^{1 / 3} ) & ( \begin{matrix}stochastic model \\ with adversarial corruptions\end{matrix} )\end{matrix}$$

In other words, it has been indicated that the regret R_{T} is bounded from above by an upper limit value A(Δ,n,C) which depends on Δ, n, and C. Here, the parameter Δ represents a suboptimality gap as with the process example 1, and the parameter C represents a corruption indicator as with the process example 1.

In the information processing apparatus 1A configured as described above, in the bandit-feedback setting, an expected value of a regret is bounded from above by an upper limit value A(Δ,n,C) which depends on Δ, n, and C, by carrying out the algorithm 2. Therefore, according to the information processing apparatus 1 configured as described above, in the bandit-feedback setting, it is possible to suitably solve an optimization problem with respect to both a stochastic model and an adversarial model.

(Relation with Lovasz Extension)

The following description will discuss a relation between the above-described algorithm 1 and algorithm 2 and Lovasz extension.

When a function f:2^{[n]}→R is given, a Lovasz extension ˜f:[0,1]n→R of a function f is given as below. Here, “˜f” represents “f” with a tilde.

First, it is assumed that a set of indices i in which xᵢ≥u for x=(x₁, x₂, . . . , xₙ)^{T}∈[0,1]ⁿ and u∈[0,1] is expressed as Hᵤ(x). That is, Hᵤ(x) is defined by Hᵤ(x)={i∈[n]|xᵢ≥u}. Using this Hᵤ(x), the Lovasz extension ˜f(x) is defined by the following formula.

$$\tilde{f} ( x ) = {E}_{u ∼ Unif ( [ 0 , 1 ] )} [ f ( {H}_{u} ( x ) ) ]$$

Here, Unif([0,1]) represents a uniform distribution on [0,1]. The Lovasz extension ˜f(x) is known to be a convex function only when the function f is submodular.

From the above definition, for an arbitrary permutation σ:[n]→[n] satisfying x_{σ(i)}≤x_{σ(i+1)} for arbitrary x∈[0,1]ⁿ and arbitrary i∈[n−1], a Lovasz extension ˜f(x) is expressed as below.

$$\tilde{f} ( x ) = {\sum }_{i = 0}^{n} ( {x}_{σ ( i + 1 )} - {x}_{σ ( i )} ) f ( σ ( [ i ] ) )$$

Here, σ[i]={σ(j)|j∈[i]}. Exceptionally, it is defined that x_{σ(0)}=0 and x_{σ(n+1)}=1.

Thus, a subgradient g(σ)∈Rⁿ of the Lovasz extension ˜f(x) is defined as below.

$$g ( σ ) = {\sum }_{i = 0}^{n} f ( σ ( [ i ] ) ) {ρ}_{i} ( σ )$$

Here, ρᵢ(σ) is as described in the algorithm 1 and algorithm 2.

The subgradient of the Lovasz extension ˜f(x) is used in both the algorithm 1 and the algorithm 2, as described above.

(Relation with FTRL Algorithm)

The following description will discuss a relation between the above-described algorithm 1 and algorithm 2 and a follow the regularized leader (FTRL) algorithm.

The FTRL algorithm is a general and sophisticated approach in online convex optimization on a subset Ω of Rⁿ. An update rule in the FTRL algorithm is expressed as below.

$${x}_{t + 1} ∈ {arg min}_{x ∈ Ω} \{ 〈 x , {\sum }_{s = 1}^{t} {g}_{s} 〉 + {ψ}_{t} ( x ) \} .$$

Here, gₜ is a subgradient of an objective function fₜ in xₜ, and ψₜ is a regularizer which is a convex function on Ω. In the FTRL algorithm, it can be indicated that, for xₜ∈Ω and arbitrary x*∈Ω, a regret is bound as follows.

$${\sum }_{t = 1}^{T} ( {f}_{t} ( {x}_{t} ) - {f}_{t} ( {x}^{*} ) ) \leq {\sum }_{t = 1}^{T} ( 〈 {g}_{t} , {x}_{t} - {x}_{t + 1} 〉 - {D}_{t} ( {x}_{t + 1} , {x}_{t} ) ) + {\sum }_{t = 1}^{T} ( {ψ}_{t} ( {x}_{t + 1} ) - {ψ}_{t + 1} ( {x}_{t + 1} ) ) + {ψ}_{T + 1} ( {x}^{*} ) - {ψ}_{1} ( {x}_{1} ) ,$$

Here, Dt is a Bergman information quantity (Bergman divergence) associated with ψₜ.

The above-described algorithm 1 corresponds to the fact that, in the FTRL algorithm, the regularizer ψₜ is defined as follows.

$${ψ}_{t} ( x ) = {\sum }_{i = 1}^{n} {λ}_{ti} ϕ ( {x}_{i} ) , \\ where \\ ϕ ( z ) = z log z + ( 1 - z ) log ( 1 - z ) .$$

Here, λₜᵢ is the learning rate described above. In the FTRL algorithm that has a regularizer defined as above, it can be indicated that xₜᵢ and a cumulative subgradient Gₜ are expressed as below.

$${x}_{ti} = \frac{1}{1 + exp ( {G}_{ti} / {λ}_{ti} )} , {G}_{t} = {\sum }_{s = 1}^{t - 1} {g}_{s} ( {σ}_{s} )$$

The above xₜᵢ and cumulative subgradient Gₜ are used in the foregoing algorithm 1.

Meanwhile, the algorithm 2 corresponds to the fact that, in the FTRL algorithm, the regularizer ψₜ is defined as follows.

$${ψ}_{t} ( x ) = - {\sum }_{i = 1}^{n} {λ}_{t} ( log ( {x}_{i} ) + log ( 1 - {x}_{i} ) )$$

In the FTRL algorithm that has a regularizer defined as above, it can be indicated that xₜᵢ is expressed as follows.

$${x}_{ti} = ζ ( \frac{{\hat{G}}_{ti}}{{λ}_{t}} )$$

Here, the function ζ is as described in the algorithm 2. The above xₜᵢ and cumulative subgradient \hat{ }Gₜ are used in the foregoing algorithm 2.

### Display Example by Information Processing System 1A

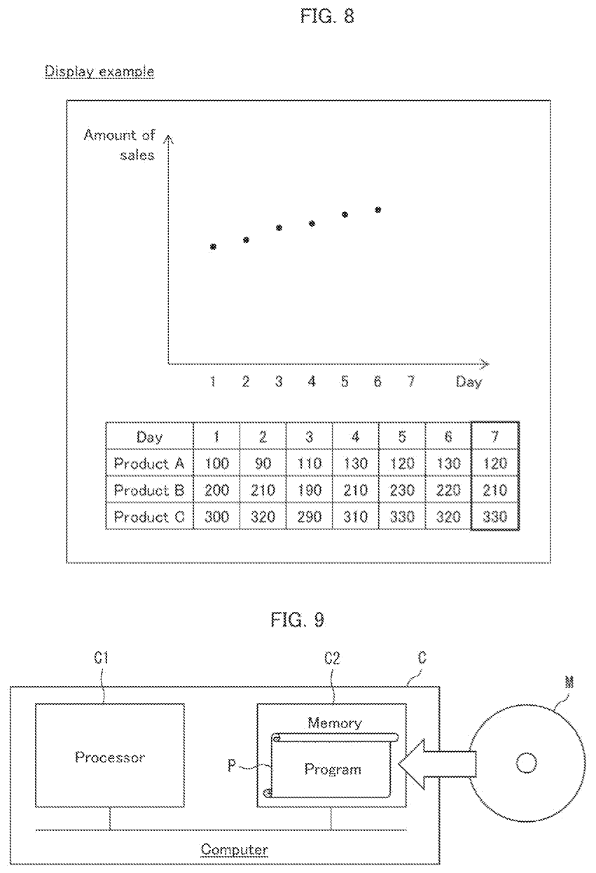

Next, a display example by the information processing system 1A will be described with reference to FIG. 8. FIG. 8 is a diagram illustrating a display example by the information processing system 1A. The example illustrated in FIG. 8 is a display example in a case where one round is set to be one day using, as an objective function, a function indicating (a total of) amounts of sales of a plurality of products. That is, in the example illustrated in FIG. 8, the selection section 11 of the information processing apparatus 1A selects a subset Xₜ in a certain day (round t) with reference to an observation value (amount of sales) of the objective function up to a previous day (round t−1) of the certain day.

Then, as illustrated in FIG. 8, the display section 27A of the terminal apparatus 2A displays, for each round (each day in FIG. 8), an observation value (amount of sales in FIG. 8) of the objective function. Furthermore, in the example illustrated in FIG. 8, the display section 27A of the terminal apparatus 2A displays information (prices of products A through C) pertaining to a subset which has been selected in the round t.

The information processing system 1A can present the amount of sales and the prices of the products to a user by carrying out such display.

### Example Applications

The foregoing information processing apparatuses 1 and 1A can be applied to various problems. Examples thereof are given below.

### (Minimum Time Path Problem)

An action is assumed to be selection of a path from one point to another point. For example, it is assumed that there are n−1 relay points from one point to another point and there are m selectable paths in each section. It is assumed to indicate that, in a case where an action measure (selected subset) Xₜ is [0, 2, 1, . . . ] in such a condition, a path 0 is selected in a first section, a path 2 is selected in a second section, and a path 1 is selected in a third section.

An objective function fₜ receives the action measure Xₜ as input and outputs a time taken to pass through a path indicated by the action measure. In this case, by applying the above-described optimization method, it is possible to derive an optimum path setting for reaching the another point from the one point in a time as short as possible.

### (Retail)

An action is assumed to be discount of prices of various kinds of beer of respective companies in a certain store. For example, it is assumed that, in a case where an action measure (selected subset) Xₜ is [0, 2, 1, . . . ], a first element indicates that a beer price of a company A is a list price, a second element indicates that a beer price of a company B is increased by 10% from a list price, and a third element indicates that a beer price of a company C is reduced by 10% from a list price.

An objective function fₜ receives the action measure Xₜ as input and outputs a result of sale made while applying the action measure X to the beer prices of the respective companies. In this case, optimum price setting of beer prices of the respective companies in the above store can be derived by applying the above-described optimization method.

### (Investment Portfolio)

The following description will discuss a case in which the method is applied to an investment action by an investor, or the like. In this case, an action measure Xₜ is assumed to be investment (purchase, capital increase), sell-off, or holding of a plurality of financial products (e.g., stock brands) which the investor is holding or intends to hold. For example, it is assumed that, in a case where an action measure (selected subset) Xₜ is [1, 0, 2, . . . ], a first element indicates an additional investment in stocks of a company A, a second element indicates holding (neither purchase nor sell-off) a credit of a company B, and a third element indicates sell-off of stocks of a company C.

An objective function fₜ receives the action measure Xₜ as input and outputs a result of applying the action measure Xₜ to the investment action with respect to financial products of the respective companies. In this case, optimum investment actions with respect to the respective brands by the investor can be derived by applying the above-described optimization method.

### (Clinical Trial)

The following description will discuss a case where the method is applied to a dosing action for a clinical trial of a certain drug in a pharmaceutical company. In this case, an action measure Xₜ is assumed to be a dosage of drug or avoidance of dosing. For example, it is assumed that, in a case where an action measure (selected subset) Xₜ is [1, 0, 2, . . . ], a first element indicates that dosing in a dosage 1 is carried out with respect to a subject A, a second element indicates that dosing is not carried out with respect to a subject B, and a third element indicates that dosing in a dosage 2 is carried out with respect to a subject C.

An objective function fₜ receives the action measure Xₜ as input and outputs a result of applying the action measure Xₜ to the dosing actions with respect to the respective subjects. In this case, optimum dosing actions with respect to the respective subjects in the clinical trial by the pharmaceutical company can be derived by applying the above-described optimization method.

### (Web Marketing)

The following description will discuss a case in which the method is applied to an advertising action (marketing measure) in an operating company of a certain electronic commerce site. In this case, an action measure Xₜ is assumed to be advertisement (an online (banner) advertisement, advertisement by e-mail, direct mail, transmission of a discount coupon by e-mail, or the like) with respect to a plurality of customers for a product or service which the operating company intends to sell. For example, it is assumed that, in a case where an action measure (selected subset) Xₜ is [1, 0, 2, . . . ], a first element indicates a banner advertisement for a customer A, a second element indicates that no advertisement is given to a customer B, and a third element indicates transmission of a discount coupon to a customer C by e-mail.

An objective function fₜ receives the action measure Xₜ as input and outputs a result of applying the action measure Xₜ to the advertising actions with respect to the respective customers. Here, execution results may be whether or not the banner advertisement has been clicked, a purchase amount, a purchase probability, and an expected value of purchase amount. In this case, optimum advertising actions with respect to the respective customers by the operating company can be derived by applying the optimization method in accordance with the present example embodiment.

### Software Implementation Example

Some or all of the functions of each of the information processing apparatuses 1 and 1A and the terminal apparatus 2A may be implemented by hardware such as an integrated circuit (IC chip), or may be implemented by software.

In the latter case, each of the information processing apparatuses 1 and 1A and the terminal apparatus 2A is realized by, for example, a computer that executes instructions of a program that is software realizing the foregoing functions. FIG. 9 illustrates an example of such a computer (hereinafter, referred to as “computer C”). The computer C includes at least one processor C1 and at least one memory C2. The memory C2 stores a program P for causing the computer C to function as the information processing apparatuses 1 and 1A and the terminal apparatus 2A. The processor C1 of the computer C retrieves the program P from the memory C2 and executes the program P, so that the functions of the information processing apparatuses 1 and 1A and the terminal apparatus 2A are implemented.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

An information processing apparatus, including: a selection means for selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and an output means for outputting information indicating the subset Xₜ⊆[n] which has been selected by the selection means, the selection means selecting the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model.

### (Supplementary Note 2)

The information processing apparatus described in supplementary note 1, in which: the gap indicator is expressed as

$$Δ = {min}_{{2}^{[ n ]} \backslash \{ {X}^{*} \}} ( \overline{f} ( X ) - \overline{f} ( {X}^{*} ) )$$

using an expected value

$$\overline{f} ( X ) = {E}_{f ∼ 𝒟} [ f ( X ) ]$$

of the objective function fₜ in a case where the objective function fₜ follows a probability distribution D; and the corruption indicator C is expressed as

$$C = {\sum }_{t = 1}^{T} {max}_{X ⊆ [ n ]} \vert {f}_{t} ( X ) - {f}_{t}^{′} ( X ) \vert$$

using the objective function fₜ and a time-dependent objective function fₜ′.

### (Supplementary Note 3)

The information processing apparatus described in supplementary note 1 or 2, further including: an acquisition means for acquiring an observation value fₜ(X) of the objective function with respect to an arbitrary subset X⊆[n] after the output means has output the subset Xₜ in the round t, the selection means being capable of referring to the observation value fₜ(X) which has been acquired by the acquisition means, and the upper limit value A(Δ,n,C) being expressed as

$$O ( \frac{n}{Δ} + \sqrt{\frac{Cn}{Δ}} ) .$$

### (Supplementary Note 4)

The information processing apparatus described in supplementary note 3, in which, the selection means carries out, in each round: a vector calculation step of calculating, for each i∈[n], an n-dimensional vector xₜ∈[0,1]ⁿ by

$${x}_{ti} = \frac{1}{1 + exp ( {G}_{ti} / {λ}_{ti} )}$$

using a learning rate λₜᵢ and a cumulative subgradient Gₜᵢ; a permutation calculation step of calculating, for all i∈[n−1], a permutation σₜ:[n]→[n] where x_{tσ(i)}≤x_{tσ(i+1)}; a random variable decision step of deciding values of a random variable uₜ which are uniformly distributed on [0,1]; a subset decision step of deciding a subset Xₜ so that Xₜ={i∈[n]|xₜᵢ≥uₜ} is satisfied; an acquisition step of acquiring an observation value fₜ(X) of an objective function; a subgradient calculation step of calculating a subgradient gₜ∈R^{d} of an objective function fₜ; and an updating step of updating a cumulative subgradient Gₜ by Gₜ₊₁=Gₜ+gₜ.

### (Supplementary Note 5)

The information processing apparatus described in supplementary note 1 or 2, further including: an acquisition means for acquiring an observation value fₜ(Xₜ) of the objective function with respect to a selected subset Xₜ after the output means has output the selected subset Xₜ in a round t, the selection means being capable of referring to an observation value fₜ(Xₜ) of the objective function with respect to the selected subset Xₜ, and being incapable of referring to an observation value fₜ(X) of the objective function with respect to a subset X⊆[n] other than the selected subset, and the upper limit value A(Δ,n,C) being expressed as

$$O ( \frac{{n}^{3} log T}{{Δ}^{2}} + {( \frac{{C}^{2} {n}^{3} log T}{{Δ}^{2}} )}^{1 / 3} ) .$$

### (Supplementary Note 6)

The information processing apparatus described in supplementary note 5, in which, the selection means carries out, in each round: a vector calculation step of calculating, for each i∈[n], an n-dimensional vector xₜ∈[0,1]ⁿ by xₜᵢ=ζ(\hat{ }Gₜᵢ/λₜ) using a learning rate λₜ, a cumulative subgradient \hat{ }Gₜᵢ, and a function ζ below,

$$Ϛ ( z ) = \{ \begin{matrix}\frac{1}{2} ( 1 + \frac{2}{g} - \sqrt{1 + \frac{4}{{g}^{2}}} ) & ( g > 0 ) \\ \frac{1}{2} ( 1 + \frac{2}{g} + \sqrt{1 + \frac{4}{{g}^{2}}} ) & ( g < 0 ) \\ 1 / 2 & ( g = 0 )\end{matrix} ;$$

a permutation calculation step of calculating, for all i∈[n−1], a permutation σₜ:[n]→[n] where x_{tσ(i)}≤x_{tσ(i+1)}; an index selection step of selecting an index iₜ∈{0, 1, . . . , n} in accordance with a probability below,

$$Prob [ {i}_{t} = i ] = {p}_{t} ( i ) = ( 1 - {γ}_{t} ) ( {x}_{t {σ}_{i} ( i + t )} - {x}_{t {σ}_{i} ( i )} ) + \frac{{γ}_{t}}{n + 1} , where$$

$${γ}_{t} = \sqrt{\frac{n}{{λ}_{t}} {\sum }_{i = 1}^{n} min {\{ {x}_{ti} , 1 - {x}_{ti} \}}^{2}} ;$$

a subset decision step of deciding a subset Xₜ so that Xₜ={σₜ(j)|j∈[iₜ]} is satisfied; a step of acquiring an observation value fₜ(Xₜ) of an objective function; a subgradient calculation step of calculating a subgradient \hat{ }gₜ∈R^{d} of an objective function fₜ; and an updating step of updating a cumulative subgradient \hat{ }Gₜᵢ by \hat{ }Gₜ₊₁=\hat{ }Gₜ+\hat{ }gₜ.

### (Supplementary Note 7)

An information processing apparatus, including: a selection means for selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and an output means for outputting information indicating the subset Xₜ⊆[n] which has been selected by the selection means, the selection means carrying out, in each round, a vector calculation step of calculating, for each i∈[n], an n-dimensional vector xₜ∈[0,1]ⁿ by

$${x}_{ti} = \frac{1}{1 + exp ( {G}_{ti} / {λ}_{ti} )}$$

using a learning rate λₜᵢ and a cumulative subgradient Gₜᵢ, a permutation calculation step of calculating, for all i∈[n−1], a permutation σₜ:[n]→[n] where x_{tσ(i)}≤x_{tσ(i+1)}, a random variable decision step of deciding values of a random variable uₜ which are uniformly distributed on [0,1], a subset decision step of deciding a subset Xₜ so that Xₜ={i∈[n]|xₜᵢ≥uₜ} is satisfied, an acquisition step of acquiring a value of an objective function fₜ(X), a subgradient calculation step of calculating a subgradient gₜ∈R^{d} of an objective function fₜ, and an updating step of updating a cumulative subgradient Gₜ by Gₜ₊₁=Gₜ+gₜ.

### (Supplementary Note 8)

An information processing apparatus, including: a selection means for selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and an output means for outputting information indicating the subset Xₜ⊆[n] which has been selected by the selection means, the selection means carrying out, in each round, a vector calculation step of calculating, for each i∈[n], an n-dimensional vector xₜ∈[0,1]ⁿ by xₜᵢ=(\hat{ }Gₜᵢ/λₜ) using a learning rate λₜ, a cumulative subgradient \hat{ }Gₜᵢ, and a function ζ below,

$$Ϛ ( z ) = \{ \begin{matrix}\frac{1}{2} ( 1 + \frac{2}{g} - \sqrt{1 + \frac{4}{{g}^{2}}} ) & ( g > 0 ) \\ \frac{1}{2} ( 1 + \frac{2}{g} + \sqrt{1 + \frac{4}{{g}^{2}}} ) & ( g < 0 ) \\ 1 / 2 & ( g = 0 )\end{matrix} ,$$

a permutation calculation step of calculating, for all i∈[n−1], a permutation σₜ:[n]→[n] where x_{tσ(i)}≤x_{tσ(i+1)}, an index selection step of selecting an index iₜ∈{0, 1, . . . , n} in accordance with a probability below,

$$Prob [ {i}_{t} = i ] = {p}_{t} ( i ) = ( 1 - {γ}_{t} ) ( {x}_{t {σ}_{i} ( i + 1 )} - {x}_{t {σ}_{i} ( i )} ) + \frac{{γ}_{t}}{n + 1} , where$$

$${γ}_{t} = \sqrt{\frac{n}{{λ}_{t}} {\sum }_{i = 1}^{n} min {\{ {x}_{ti} , 1 - {x}_{ti} \}}^{2}} ,$$

a subset decision step of deciding a subset Xₜ so that Xₜ={σₜ(j)|j∈[iₜ]} is satisfied, a step of acquiring a value of an objective function fₜ(Xₜ), a subgradient calculation step of calculating a subgradient \hat{ }gₜ∈R^{d} of an objective function fₜ, and an updating step of updating a cumulative subgradient \hat{ }Gₜᵢ by \hat{ }Gₜ₊₁=\hat{ }Gₜ+\hat{ }gₜ.

### (Supplementary Note 9)

An information processing method, including: selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and outputting information indicating the subset Xₜ⊆[n] which has been selected, in the selecting, the subset Xₜ⊆[n] being selected so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and an optimum solution X*, is bounded from above by an upper limit value A(Δ,n,C) which depends at least on a gap indicator Δ in a stochastic model and on a corruption indicator C indicating an adversarial corruption of the stochastic model.

### (Supplementary Note 10)

An information processing program for causing a computer to carry out: a process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and a process of outputting information indicating the subset Xₜ⊆[n] which has been selected, in the process of selecting, the subset Xₜ⊆[n] being selected so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and an optimum solution X*, is bounded from above by an upper limit value A(Δ,n,C) which depends at least on a gap indicator Δ in a stochastic model and on a corruption indicator C indicating an adversarial corruption of the stochastic model.

### (Supplementary Note 11)

A computer-readable storage medium storing a program described in supplementary note 10.

### (Supplementary Note 12)

An information processing apparatus including at least one processor, the at least one processor carrying out: a process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and a process of outputting information indicating the subset Xₜ⊆[n] which has been selected, in the process of selecting, the subset Xₜ⊆[n] being selected so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and an optimum solution X*, is bounded from above by an upper limit value A(Δ,n,C) which depends at least on a gap indicator Δ in a stochastic model and on a corruption indicator C indicating an adversarial corruption of the stochastic model.

Note that the information processing apparatus can further include a memory. The memory can store a program for causing the at least one processor to carry out the selecting process and the outputting process. The program can be stored in a computer-readable non-transitory tangible storage medium.

### REFERENCE SIGNS LIST

1, 1A: Information processing apparatus
11: Selection section (selection means)
12: Output section (output means)
13: Acquisition section

What is claimed is:

1. An information processing apparatus, comprising at least one processor, the at least one processor carrying out:
a selection process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and
an output process of outputting information indicating the subset Xₜ⊆[n] which has been selected in the selection process,
in the selection process, the at least one processor selecting the subset Xₜ⊆[n] so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and a comparative solution X*, is bounded from above by an upper limit value A(Δ,n,C) which depends at least on a gap indicator Δ in a stochastic model and on a corruption indicator C indicating an adversarial corruption of the stochastic model.

2. The information processing apparatus as set forth in claim 1, wherein:
the gap indicator is expressed as
$$Δ = {min}_{{2}^{\{ n \}} \backslash \{ {X}^{*} \}} ( \overline{f} ( X ) - \overline{f} ( {X}^{*} ) )$$
using an expected value
$$\overline{f} ( X ) = {E}_{f ∼ D} [ f ( X ) ]$$
of the objective function fₜ in a case where the objective function fₜ follows a probability distribution D; and
the corruption indicator C is expressed as
$$C = {\sum }_{t = 1}^{T} {max}_{X ⊆ [ n ]} \vert {f}_{t} ( X ) - {f}_{t}^{′} ( X ) \vert$$
using the objective function fₜ and a time-dependent objective function fₜ′.

3. The information processing apparatus as set forth in claim 1, wherein:
the at least one processor further carries out an acquisition process of acquiring an observation value fₜ(X) of the objective function with respect to an arbitrary subset X⊆[n] after outputting the subset Xₜ in the round t in the output process;
in the selection process, the at least one processor is capable of referring to the observation value fₜ(X) which has been acquired in the acquisition process; and
the upper limit value A(Δ,n,C) is expressed as
$$O ( \frac{n}{Δ} + \sqrt{\frac{Cn}{Δ}} )$$

4. The information processing apparatus as set forth in claim 3, wherein, in the selection process, in each round:
the at least one processor calculates, for each i∈[n], an n-dimensional vector xₜ∈[0,1]ⁿ by
$${x}_{ti} = \frac{1}{1 + exp ( {G}_{ti} / {λ}_{ti} )}$$
using a learning rate λₜᵢ and a cumulative subgradient Gₜᵢ;
the at least one processor calculates, for all i∈[n−1], a permutation σₜ:[n]→[n] where x_{tσ(i)}≤x_{tσ(i+1)};
the at least one processor decides values of a random variable uₜ which are uniformly distributed on [0,1];
the at least one processor decides a subset Xₜ so that Xₜ={i∈[n]|xₜᵢ≥uₜ} is satisfied;
the at least one processor acquires an observation value fₜ(X) of an objective function;
the at least one processor calculates a subgradient gₜ∈R^{d} of an objective function fₜ; and
the at least one processor updates a cumulative subgradient Gₜ by Gₜ₊₁=Gₜ+gₜ.

5. The information processing apparatus as set forth in claim 1, wherein:
the at least one processor further carries out an acquisition process of acquiring an observation value fₜ(Xₜ) of the objective function with respect to a selected subset Xₜ after outputting the selected subset Xₜ in a round t in the output process;
in the selection process, the at least one processor is capable of referring to an observation value fₜ(Xₜ) of the objective function with respect to the selected subset Xₜ, and is incapable of referring to an observation value fₜ(X) of the objective function with respect to a subset X⊆[n] other than the selected subset; and
the upper limit value A(Δ,n,C) is expressed as
$$O ( \frac{{n}^{3} log T}{{Δ}^{2}} + {( \frac{{C}^{2} {n}^{3} log T}{{Δ}^{2}} )}^{1 / 3} ) .$$

6. The information processing apparatus as set forth in claim 5, wherein, in the selection process, in each round:
the at least one processor calculates, for each i∈[n], an n-dimensional vector xₜ∈[0,1]ⁿ by xₜᵢ=ζ(\hat{ }Gₜᵢ/λₜ) using a learning rate λₜ, a cumulative subgradient \hat{ }Gₜᵢ, and a function ζ below,
$$Ϛ ( z ) = \{ \begin{matrix}\frac{1}{2} ( 1 + \frac{2}{g} - \sqrt{1 + \frac{4}{{g}^{2}}} ) & ( g > 0 ) \\ \frac{1}{2} ( 1 + \frac{2}{g} + \sqrt{1 + \frac{4}{{g}^{2}}} ) & ( g < 0 ) \\ 1 / 2 & ( g = 0 )\end{matrix} ;$$
the at least one processor calculates, for all i∈[n−1], a permutation σₜ:[n]→[n] where x_{tσ(i)}≤x_{tσ(i+1)};
the at least one processor selects an index iₜ ∈{0, 1, . . . , n} in accordance with a probability below,
$$Prob [ {i}_{t} = i ] = {p}_{t} ( i ) = ( 1 - {γ}_{t} ) ( {x}_{t {σ}_{i} ( i + 1 )} - {x}_{t {σ}_{i} ( i )} ) + \frac{{γ}_{t}}{n + 1} , where$$
$${γ}_{t} = \sqrt{\frac{n}{{λ}_{t}} {\sum }_{i = 1}^{n} min {\{ {x}_{ti} , 1 - {x}_{ti} \}}^{2}} ;$$
the at least one processor decides a subset Xₜ so that Xₜ={σₜ(j)|j∈[iₜ]} is satisfied;
the at least one processor acquires an observation value fₜ(Xₜ) of an objective function;
the at least one processor calculates a subgradient \hat{ }gₜ∈R^{d} of an objective function fₜ; and
the at least one processor updates a cumulative subgradient \hat{ }Gₜᵢ by \hat{ }Gₜ₊₁=\hat{ }Gₜ+\hat{ }gₜ.

7. An information processing apparatus, comprising at least one processor, the at least one processor carrying out:
a selection process of selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and
an output process of outputting information indicating the subset Xₜ⊆[n] which has been selected in the selection process,
in the selection process, in each round,
the at least one processor calculating, for each i∈[n], an n-dimensional vector xₜ∈[0,1]ⁿ by
$${x}_{ti} = \frac{1}{1 + exp ( {G}_{ti} / {λ}_{ti} )}$$
using a learning rate λₜᵢ and a cumulative subgradient Gₜᵢ,
the at least one processor calculating, for all i∈[n−1], a permutation σₜ:[n]→[n] where x_{tσ(i)}≤x_{tσ(i+1)},
the at least one processor deciding values of a random variable uₜ which are uniformly distributed on [0,1],
the at least one processor deciding a subset Xₜ so that Xₜ={i∈[n]|xₜᵢ≥uₜ} is satisfied,
the at least one processor acquiring a value of an objective function fₜ(X),
the at least one processor calculating a subgradient gₜ∈R^{d} of an objective function fₜ, and
the at least one processor updating a cumulative subgradient Gₜ by Gₜ₊₁=Gₜ+gₜ.

8. (canceled)

9. An information processing method, comprising:
selecting a subset Xₜ⊆[n] of a set [n]={1, 2, . . . , n} (where n is an arbitrary natural number) in a certain round t∈[T] (where T is an arbitrary natural number) with reference to an observation value of an objective function in a round t−1; and
outputting information indicating the subset Xₜ⊆[n] which has been selected,
in the selecting, the subset Xₜ⊆[n] being selected so that an asymptotic behavior of an expected value of a regret Σ_{t∈[T]}fₜ(Xₜ)−Σ_{t∈[T]}fₜ(X*), which is expressed using an observation value fₜ(Xₜ) of an objective function in each round t∈[T] and an optimum solution X*, is bounded from above by an upper limit value A(Δ,n,C) which depends at least on a gap indicator Δ in a stochastic model and on a corruption indicator C indicating an adversarial corruption of the stochastic model.

10. A computer-readable non-transitory storage medium storing a program for causing a computer to function as an information processing apparatus recited in claim 1, the program causing the computer to carry out the selection process and the output process.
